(19) United States
(12) Patent Application Publication
(10) Pub. No.: US 2026/0094944 A1
(43) Pub. Date: Apr. 2, 2026

(54) SECONDARY BATTERY AND METHOD OF MANUFACTURING SECONDARY BATTERY

(71) Applicant: SAMSUNG SDI CO., LTD., Yongin-si (KR)

(72) Inventors: Kyungtae KIM, Yongin-si (KR); Sungjoon CHO, Yongin-si (KR)

(21) Appl. No.: 19/272,079

(22) Filed: Jul. 17, 2025

(30) Foreign Application Priority Data
Sep. 27, 2024 (KR) 10-2024-0131478

(51) Int. Cl. H01M 50/477; H01M 10/04; H01M 50/107; H01M 50/119; H01M 50/486; H01M 50/578

(52) U.S. Cl. CPC H01M 50/477; H01M 10/049; H01M 50/107; H01M 50/119; H01M 50/486; H01M 50/578

(57) ABSTRACT

A secondary battery includes a first can having a first screw thread formed on an outer circumferential surface of the first can, an electrode assembly accommodated in the first can, and a second can having a second screw thread corresponding to the first screw thread formed on an inner circumferential surface of the second screw thread. The second screw thread corresponding to the first screw thread such that the second can be screwed to the first can to seal an opening of the first can.

### CROSS-REFERENCE TO RELATED APPLICATION

This application claims priority under 35 U.S.C. § 119 to Korean Patent Application No. 10-2024-0131478, filed in the Korean Intellectual Property Office on Sep. 27, 2024, the entire contents of which are hereby incorporated by reference.

### BACKGROUND

### Technical Field

Aspects of embodiments of the present disclosure relate to a secondary battery and a method of manufacturing the secondary battery.

### Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

In general, in a cylindrical can of a cylindrical secondary battery, a beading part is formed inwardly concave at the bottom of a cap plate and a crimping part is formed inwardly bent at the top of the beading part. The beading and crimping parts retain the cap plate that seals the cylindrical can. A insulating gasket, which is positioned to insulate between the cap plate and the cylindrical can, is seated in contact with the beading part and the crimping part.

Space is needed inside the cylindrical can in order to increase the capacity of secondary batteries. However, when a physical deformation process is used to form the beading part or the crimping part of the cylindrical can, there may be a limitation on the thickness of the can. In addition, because an electrode assembly cannot extend into the upper space of the cylindrical can, there is a limitation on the possible capacity of the battery. Furthermore, there may be a problem that an assembly process of a secondary battery is complicated by positioning a separate insulating gasket and a cap plate with the cylindrical can.

The above information disclosed in this Background section is for enhancement of understanding of the background of the present disclosure, and therefore, it may contain information that does not constitute related (or prior) art.

### SUMMARY

Aspects of embodiments of the present disclosure provide a secondary battery for solving the problems described above and a method of manufacturing the secondary battery.

However, the technical problem to be solved by the present disclosure is not limited to the above problems, and other problems not mentioned herein, and aspects and features of the present disclosure that would address such problems, will be clearly understood by those skilled in the art from the description of the present disclosure below.

Aspects of embodiments provide a secondary battery including a first can having a first screw thread formed on an outer circumferential surface of the first can, an electrode assembly accommodated in the first can and a second can having a second screw thread formed on an inner circumferential surface of the second can, with the second screw thread corresponding to the first screw thread, and the first can and the second can being screwed together by the first and second screw threads to thereby seal an opening of the first can.

According to one embodiment, the first can may include a bottom part electrically connected to the electrode assembly and a cylindrical-shaped base part extending from the bottom part, with the first screw thread being formed on an outer circumferential surface of the base part.

According to one embodiment, the first screw thread may be formed on the outer circumferential surface of the base part from a first end that is adjacent to the bottom part to a second end that is adjacent to an opening of the first can.

According to one embodiment, the bottom part and the base part may be formed from nickel or a nickel alloy material.

According to one embodiment, the second can may include a cap part electrically connected to the electrode assembly and a cylindrical-shaped base part extending from the cap part, with the second screw thread being formed on an inner circumferential surface of the base part.

According to one embodiment, the cap part may include a current interrupt device (CID).

According to one embodiment, the second screw thread may be formed on the inner circumferential surface of the second base part from a first end that is adjacent to the cap part to a second end that is adjacent to the opening of the second can.

According to one embodiment, the cap part and the second base part may be formed from aluminum or an aluminum alloy material.

According to one embodiment, the first screw thread and the second screw thread may be formed from an insulating material that insulates the first can and the second can.

According to one embodiment, the first screw thread and the second screw thread may be formed from a polyethylene (PE)-based or a polypropylene (PP)-based material.

According to one embodiment, may further include a sealing part joined to the first can by the first can being screwed to the second can.

Aspects of embodiments provide a method for manufacturing a secondary battery including coating an insulating material on an outer circumferential surface of a first can, coating an insulating material on an inner circumferential surface of a second can, forming a first screw thread by cutting the insulating material of the first can and forming a second screw thread by cutting the insulating material of the second can, with the second thread being formed to correspond to the first screw thread, inserting an electrode assembly into the first can and rotating the first can to screw the first can to the second can while the first screw thread and the second screw thread are engaged to each other.

According to one embodiment, the first can may include a bottom part electrically connected to the electrode assembly and a cylindrical-shaped base part extending from the bottom part, with the first screw thread being formed on an outer circumferential surface of the base part.

According to one embodiment, in the forming the first screw thread, the first screw thread may be formed on the outer circumferential surface of the base part from a first end that is adjacent to the bottom part to a second end that is adjacent to an opening of the first can.

According to one embodiment, the second can may include a cap part electrically connected to the electrode assembly and a cylindrical-shaped base part extending from the cap part, with the second screw thread being formed on an inner circumferential surface of the base part.

According to one embodiment, the cap part may include a current interrupt device (CID).

According to one embodiment, in forming the second screw thread, the second screw thread may be formed on the inner circumferential surface of the second base part from a first end that is adjacent to the cap part to a second end that is adjacent to the opening of the second can.

According to one embodiment, the first screw thread and the second screw thread may be formed of from insulating material that insulates between the first can and the second can.

According to one embodiment, the first screw thread and the second screw thread may be formed of a polyethylene (PE)-based or polypropylene (PP)-based material.

According to one embodiment, may further include, after the first can and the second can are screwed together, a sealing part is joined to the first can.

According to various embodiments of the present disclosure, the beading part or the crimping part for seating a separate insulating gasket on the cylindrical can is unnecessary. Thus, the can may be formed with a small thickness, thereby improving the capacity of the secondary battery.

According to various embodiments of the present disclosure, insulation between the positive electrode and the negative electrode is possible without forming the beading part in the cylindrical can. Accordingly, the volume of the electrode assembly accommodated in the internal space of the can may be increased, thereby increasing the capacity of the secondary battery.

According to various embodiments of the present disclosure, the process of assembling and sealing the separate insulating gasket and the cap plate on the cylindrical can may be eliminated, thereby simplifying the assembling process.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a perspective view of a secondary battery according to an embodiment of the present disclosure.

FIG. 2 is a cross-sectional view of the secondary battery shown in FIG. 1.

FIG. 3 is a cross-sectional view of a first can of a secondary battery according to an embodiment of the present disclosure.

FIG. 4 is an enlarged view of region A of FIG. 3.

FIG. 5 is a cross-sectional view showing a second can of a secondary battery according to an embodiment of the present disclosure.

FIG. 6 is an enlarged view of region B of FIG. 5.

FIG. 7 illustrates a sealing part in a secondary battery according to an embodiment of the present disclosure.

FIG. 8 is a flowchart showing a method of manufacturing a secondary battery according to an embodiment of the present disclosure.

FIG. 9 illustrate a first can accommodating an electrode assembly and screwed to a second can in a method of manufacturing a secondary battery according to an embodiment of the present disclosure.

FIG. 10 is a cross-sectional view of an insulating material before a first screw thread is formed in a method of manufacturing a secondary battery according to an embodiment of the present disclosure.

FIG. 11 is a cross-sectional view of a first screw thread formed by cutting the insulating material shown in FIG. 10.

FIG. 12 is a cross-sectional view showing an insulating material before a second screw thread is formed in a method of manufacturing a secondary battery according to an embodiment of the present disclosure.

FIG. 13 is a cross-sectional view showing the second screw thread formed by cutting the insulating material shown in FIG. 12.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. §132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed”between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure do not necessarily limit the full scope of the present disclosure.

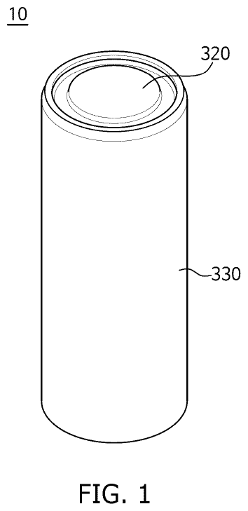

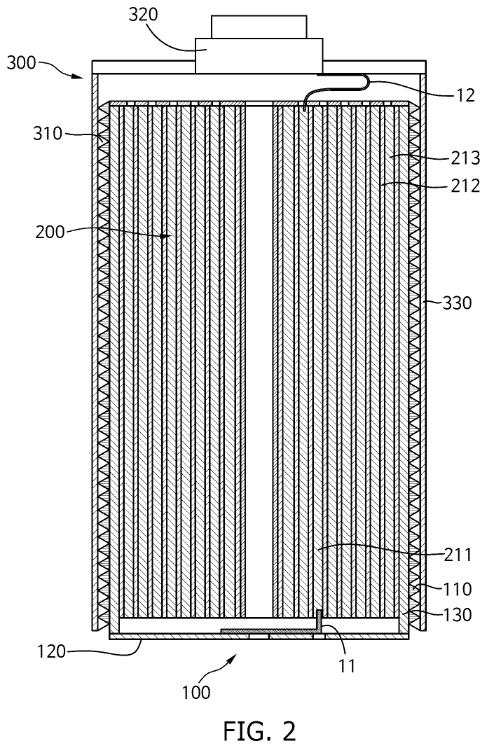

FIG. 1 is a perspective view of a secondary battery according to an embodiment of the present disclosure, and FIG. 2 is a cross-sectional view of the secondary battery.

Referring to FIGS. 1 and 2, a secondary battery 10 may include a first can 100, an electrode assembly 200, and a second can 300. The secondary battery 10 is shown as a cylindrical battery. The present disclosure is not limited thereto, as the secondary battery may be other types, such as a coin-type battery having a cylindrical shape.

The first can 100 may include a circular bottom part 120 and a first base part 130 that extends upward from the bottom part 120 by a certain length (as shown in FIG. 2). The first base part 130 may have a cylindrical shape. In an embodiment, the first can 100 may include or be referred to as a case, an exterior member, or a housing.

During a secondary battery manufacturing process, the upper portion of the first can 100 may be open. Therefore, during the process of assembling the secondary battery, the electrode assembly 200 may be accommodated in the first can 100 and electrolyte may be added to the first can 100.

The first can 100 may have a first screw thread 110 formed on an outer circumferential surface thereof. The first screw thread 110 may be formed to extend in the longitudinal direction of the outer circumferential surface of the first can 100. The first screw thread 110 may be formed on the outer circumferential surface of the first base part 130 from a first end that is adjacent to the bottom part 120 to a second end that is adjacent to the opening side of the first can 100. In an embodiment, the first screw thread 110 may extend in a spiral manner along the longitudinal direction of the outer circumferential surface of the first can 100. The angle of the first screw thread 110 may be, for example, 50° to 60°. However, in the present disclosure, the angle of the first screw thread 110 is not limited.

The width of the first screw thread 110 may be widest at the out circumferential surface of the first can 100 and may become narrower as the distance from the outer circumferential surface increases. That is, the width of the first screw thread 110 may become narrower as the distance in the radial direction of the first can 100 increases. The inner diameter of the first screw thread 110 may be defined by the outer diameter of the first can 100, and the outer diameter of the first screw thread 110 may be defined by the outer surface of the first screw thread 110.

The first screw thread 110 depicted in FIG. 2 is shown as having a shape with sharp edges, but the first screw thread 110 may also be formed to have a shape with round edges. The present disclosure is not limited with respect to the shape of the first screw thread 110.

The second can 300 may be screwed to the first can 100. In an embodiment, the second can 300 may include or be referred to as a case, an exterior member, or a housing. The second can 300 may be joined to the first can 100 to form the case of the secondary battery 10. The second can 300 may include a circular cap part 320 and a second base part 330 extending downward from the cap part 320 by a certain length. The second base part 330 may be a cylindrical shape. The upper portion may refer to an end where the cap part 320 is positioned in the longitudinal direction of the secondary battery 10. Similarly, the lower part may refer to an end that is opposite to the upper part in the longitudinal direction of the secondary battery.

During a secondary battery manufacturing process, the lower portion of the second can 300 may be open. Accordingly, the process of assembling the secondary battery, the first can 100 in which the electrode assembly 200 is positioned may be joined to the second can 300, and the opening in the first can 100 may be sealed by the second can 300.

The second can 300 may have a second screw thread 310 formed on an inner circumferential surface thereof. The second screw thread 310 may be formed to correspond to the first screw thread 110. That is, the second screw thread 310 may be formed to correspond to the first screw thread 110 so that the second screw thread 310 and the first screw thread 110 engage each other as the first can 100 or the second can 300 rotates.

The second screw thread 310 may be formed to extend in the longitudinal direction of the inner circumferential surface of the second can 300. That is, the second screw thread 310 may be formed on the inner circumferential surface of the second base part 330 from a first end adjacent to the cap part 320 to the second end that is adjacent to on the opening in the second can 300. In an embodiment, the second screw thread 310 may extend in a spiral manner along the longitudinal direction of the inner circumferential surface of the second can 300. The angle of the second screw thread 310 may be, for example, 50° to 60°. However, in the present disclosure, the angle of the second screw thread 310 may be variously modified to correspond to the first screw thread 110.

The width of the second screw thread 310 may be widest at a position where the second screw thread 310 at the inner circumferential surface of the second can 300 and may become narrower as the distance from the surface increases. That is, the width of the second screw thread 310 may become narrower as the distance in the radial direction of the second can 300 increases. The outer diameter of the second screw thread 310 may be defined by the inner diameter of the second can 300, and the inner diameter of the second screw thread 310 may be defined by the outer surface of the second screw thread 310.

The second screw thread 310 in the drawing is shown as having a shape with sharp edges, but the second screw thread 310 may also be formed to have a shape with round edges. The present disclosure is not limited with respect to the shape of the second screw thread 310.

In an embodiment, the electrode assembly 200 may be accommodated inside the first can 100. The bottom part 120 of the first can 100 may be electrically connected to the electrode assembly 200. In some embodiments, the cap part 320 may be electrically connected to the electrode assembly 200.

The second can 300 may be screwed to the first can 100 to seal the upper portion of the first can 100. In the present disclosure, the secondary battery 10 may cylindrical shaped. In this case, the cap part 320 may have a disc shape. FIG. 2 shows a cross-sectional view along the diameter of the cap part 320. The second can 300 may seal the opening of the first can 100 to protect the electrode assembly 200 from the external environment.

The electrode assembly 200 may be in a stacked form in which a first electrode plate 211, a second electrode plate 212, and a separator 213 are sequentially stacked. The first electrode plate 211, the second electrode plate 212, and the separator 213 may be wound in a cylindrical shape.

The first electrode tab 11 may be connected to the first electrode plate 211 and may be joined to the bottom part 120 of the first can 100. The second electrode tab 12 may be connected to the second electrode plate 212 and may be joined to the cap part 320 of the second can 300. The electrode assembly 200 may be accommodated in the internal space of the first can 100. The electrode assembly 200 may include or be referred to as an electrode, an electrode group, or a jelly roll.

The electrode assembly 200 may include the first electrode plate 211 coated with a negative electrode active material, the second electrode plate 212 coated with a positive electrode active material, and the separator 213. The separator 213 may be positioned between the first electrode plate 211 and the second electrode plate 212 to prevent a short circuit and may allow only the movement of lithium ions between the first and second electrode plates 211 and 212.

When the first electrode plate 211 is a negative electrode plate, a negative electrode substrate may be composed of, for example, copper foil or nickel foil, and a negative electrode active material may include, for example, graphite. The negative electrode active material may include a material that reversibly intercalates/deintercalates lithium ions, a lithium metal, a lithium metal alloy, a material capable of doping/dedoping lithium, or a transition metal oxide. The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO₂, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

When the second electrode plate 212 is a positive electrode plate, a positive electrode substrate may be composed of aluminum foil, and a positive electrode active material may include, for example, a transition metal and an oxide.

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L¹ is Mn, Al, or a combination thereof.

The positive electrode active material may be, for example, a high nickel-based positive electrode active material having a nickel content of greater than or equal to about 80 mol%, greater than or equal to about 85 mol%, greater than or equal to about 90 mol%, greater than or equal to about 91 mol%, or greater than or equal to about 94 mol% and less than or equal to about 99 mol% based on 100 mol% of the metal excluding lithium in the lithium transition metal composite oxide. The high-nickel-based positive electrode active material may be capable of realizing high capacity and can be applied to a high-capacity, high-density rechargeable lithium battery.

The separator may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one or both surfaces of the porous substrate.

The porous substrate may be a polymer film formed of any one selected polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON®, and polytetrafluoroethylene, or a copolymer or mixture of two or more thereof.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked.

A first electrode tab 11 that protrudes downward by a certain length may be connected (e.g., welded) to the first electrode plate 211, and a second electrode tab 12 that protrudes upward by a certain length may be connected (e.g., welded) to the second electrode plate 212. In some embodiments, the first electrode tab 11 may be copper (Cu) or nickel (Ni), and the second electrode tab 12 may be aluminum (Al).

In some embodiments, the first electrode tab 11 of the electrode assembly 200 may be connected to the bottom part 120 of the first can 100. Therefore, the first can 100 may operate as a negative electrode. The first electrode tab 11 may be welded to the bottom part 120 of the first can 100, for example, by ultrasonic waves or laser.

In some embodiments, the second electrode tab 12 of the electrode assembly 200 may be connected to the cap part 320 of the second can 300. Therefore, the second can 300 may operate as a positive electrode. The second electrode tab 12 may be welded to the cap part 320 of the second can 300, for example, by ultrasonic waves or laser.

In an embodiment, the first screw thread 110 and the second screw thread 310 may be formed of an insulating material that insulates between the first can 100 and the second can 300. For example, the first screw thread 110 and the second screw thread 310 may be formed of a polyethylene (PE)-based or polypropylene (PP)-based material. Accordingly, when the first can 100 is screwed to the second can 300, the internal space of the first can 100 may be sealed, and at the same time, the first can 100 and the second can 300 may be insulated from each other.

In an embodiment, the insulating material may include or be referred to as a sealing gasket, an insulator, or a resin. The first screw thread 110 and the second screw thread 310 may be formed of a resin material such as polyethylene (PE), polypropylene (PP), polyethylene terephthalate (PET), etc. But the present disclosure is not limited thereto.

In comparative examples of a cylindrical secondary battery, an insulating gasket may be positioned to insulate between the cap plate and the cylindrical case. That is, a separate insulating gasket is positioned to insulate between the cap plate functioning as the positive electrode and the cylindrical case functioning as the negative electrode. The insulating gasket may come into contact with and be fixed to the bent beading part formed in the cylindrical case. In such a configuration, a process of forming a separate beading part is required for seating the insulating gasket on the side surface of the cylindrical case.

As discussed above, in some embodiments of the present disclosure, the first screw thread 110 and the second screw thread 310 may be formed of an insulating material that insulates between the first can 100 and the second can 300,. Thus, a separate insulating gasket is not required. Accordingly, there is no need to form separate beading parts in the first can 100 and the second can 300, and the first can 100 and the second can 300 may be formed with a small thickness, thereby improving the capacity of the secondary battery. Further, the volume of the electrode assembly 200 accommodated in the internal space of the first can 100 may be further increased, thereby improving the capacity of the secondary battery 10. Still further, the assembly process may be simplified by eliminating the process of forming the beading part for the insulating gasket and the process of assembling and sealing the insulating gasket and the cap plate into the cylindrical case.

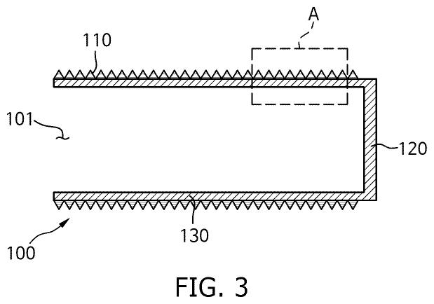

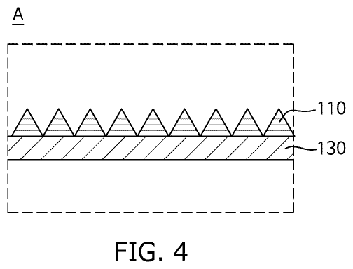

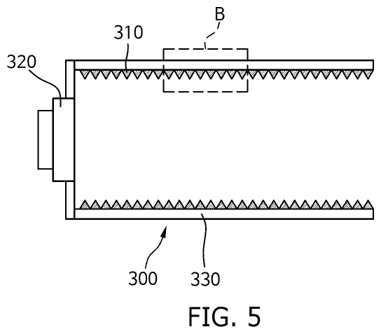

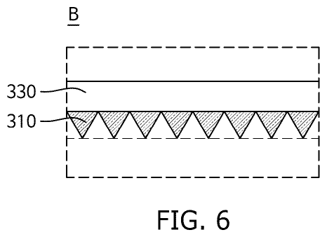

FIG. 3 is a cross-sectional view showing a first can of a secondary battery according to an embodiment of the present disclosure, FIG. 4 is an enlarged view of region A of FIG. 3, FIG. 5 is a cross-sectional view showing a second can of a secondary battery according to an embodiment of the present disclosure, and FIG. 6 is an enlarged view of region B of FIG. 5.

Referring to FIGS. 3 to 6, the first can 100 may include an opening 101 through which the electrode assembly 200 is inserted into the first can 100. The second can 300 may be screwed to the first can 100 to seal the opening 101 of the first can 100. The first can 100 may include the bottom part 120 and the first base part 130.

In an embodiment, the first base part 130 may be cylindrical shaped and extend from the bottom part 120. The first base part 130 may have the first screw thread 110 formed on an outer circumferential surface thereof. The first screw thread 110 may be formed on the outer circumferential surface of the first base part 130 from a first end that is adjacent to the bottom part 120 to the second end adjacent to the opening in the first can 100.

In an embodiment, the bottom part 120 and the first base part 130 may be formed of nickel or a nickel alloy material. When the bottom part 120 and the first base part 130 are formed of nickel or a nickel alloy material, the bottom part 120 may function as a negative electrode.

The first screw thread 110 may be an insulating material surrounding the outer circumferential surface of the first base part 130. The first screw thread 110 formed by coating or the like the insulating material on the outer circumferential surface of the first base part 130 (as shown by the dashed line in FIG. 4) and then cutting the insulating material in a screw thread shape.

The second can 300 may include the cap part 320 and the second base part 330. The upper surface of the cap part 320 may be exposed to outside of the secondary battery and electrically connected to an external device to serve as a terminal. In an embodiment, the cap part 320 may be a positive terminal.

In some embodiments, the cap part 320 may include a current interrupt device (CID). Cylindrical secondary batteries include an internal CID ensure the safety of the battery. The CID is a protective device that may prevent the explosion of the battery in an event where the pressure rises inside the secondary battery. The cap part 320 may block the flow of current from the electrode assembly to the second can 300 when the internal pressure of the secondary battery including the CID increases, thereby preventing the battery from being further charged.

In an embodiment, the second base part 330 may extend from the cap part 320 and be cylindrical shaped. The second base part 330 may have the second screw thread 310 formed on an inner circumferential surface thereof. The second screw thread 310 may be formed on the inner circumferential surface of the second base part 330 from a first end that is adjacent to the cap part 320 to a second end that is adjacent to the opening.

In an embodiment, the cap part 320 and the second base part 330 may be formed of aluminum or an aluminum alloy material. in particular, when the cap part 320 and the second base part 330 are formed of aluminum or an aluminum alloy material, the cap part 320 may function as a positive electrode.

The second screw thread 310 may be an insulating material surrounding the inner circumferential surface of the second base part 330. The second screw thread 310 may be formed by coating or the like the insulating material on the inner circumferential surface of the second base part 330 (as indicated by the dashed line in FIG. 6) and then cutting the insulating material in a screw thread shape.

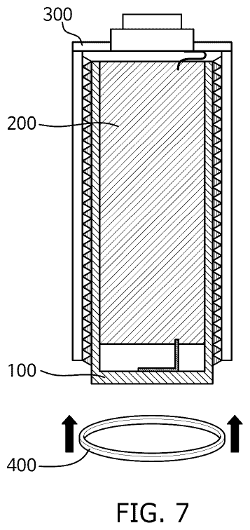

FIG. 7 illustrates a sealing part in a secondary battery according to an embodiment of the present disclosure.

Referring to FIG. 7, the secondary battery according to an embodiment of the present disclosure may further include a sealing part 400 joined to the first can 100 when the first can 100 is screwed to the second can 300. The sealing part 400 may be joined to the lower portion of the first can 100 and may seal adjacent to a position where the first screw thread 110 and the second screw thread 310 are engaged with each other.

In an embodiment, the sealing part 400 may be ring shaped with a circular cross-section. For example, the sealing part 400 may be in the form of an O-ring, but the shape of the sealing part 400 is not limited in the present disclosure. The sealing part 400 may be formed of a material such as rubber, silicone, or TEFLON®. The sealing part 400 is not limited as long as the sealing part 400 is formed of a material that can come into contact with the first can 100.

The sealing part 400 may maintain the sealing at the end where the first screw thread 110 and the second screw thread 310 are engaged with each other while coming into contact with the first can 100 along the outer circumference of the first can 100. Accordingly, the secondary battery according to the present disclosure may be have two seals by including the sealing part 400 along with the engagement of the first screw thread 110 and the second screw thread 310.

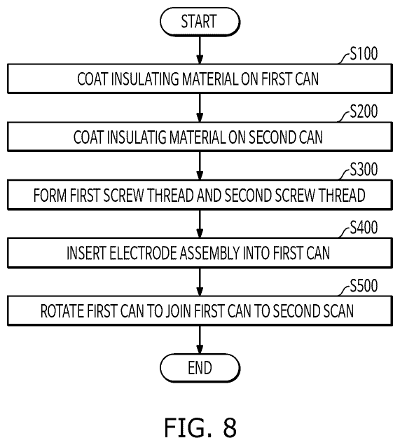

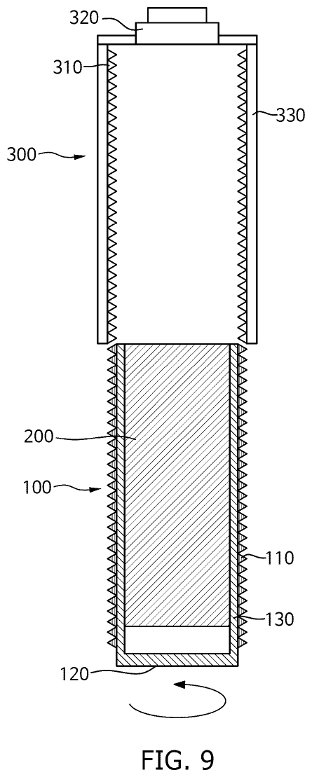

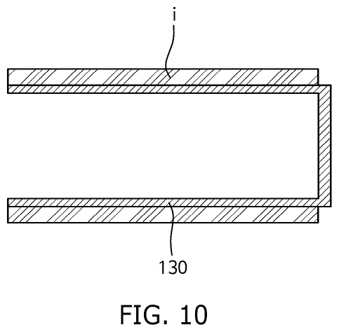

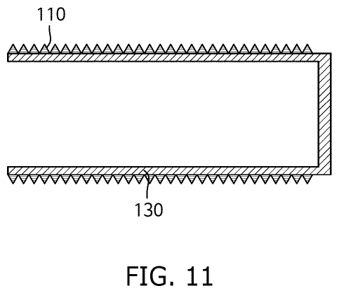

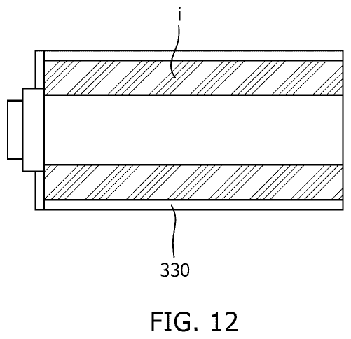

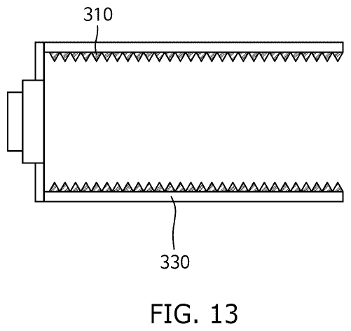

FIG. 8 is a flowchart showing a method of manufacturing a secondary battery according to an embodiment of the present disclosure, and FIG. 9 illustrates a first can accommodating an electrode assembly being screwed to a second can in a method of manufacturing a secondary battery according to an embodiment of the present disclosure. FIG. 10 is a cross-sectional view showing an insulating material before a first screw thread is formed in a method of manufacturing a secondary battery according to an embodiment of the present disclosure, FIG. 11 is a cross-sectional view showing that the first screw thread is formed by cutting the insulating material shown in FIG. 10, FIG. 12 is a cross-sectional view showing an insulating material before a second screw thread is formed in a method of manufacturing a secondary battery according to an embodiment of the present disclosure, and FIG. 13 is a cross-sectional view showing that the second screw thread is formed by cutting the insulating material shown in FIG. 12.

Referring to FIGS. 8 to 13, a method of manufacturing a secondary battery according to an embodiment of the present disclosure may include coating an insulating material on an outer circumferential surface of a first can (S100), coating an insulating material on an inner circumferential surface of a second can (S200), forming a first screw thread and a second screw thread (S300), inserting an electrode assembly into the first can (S400), and rotating the first can to screw the first can to the second can (S500).

As shown in FIG. 10, in the step S100 of coating the insulating material on the outer circumferential surface of the first can, an insulating material i may be coated on an outer circumferential surface of a first base part 130 to a certain thickness. Similarly, in the step S200 of coating the insulating material on the inner circumferential surface of the second can as shown in FIG. 12, an insulating material i may be coated on an inner circumferential surface of a second base part 330 to a certain thickness.

Thereafter, the step S300 of forming the first screw thread and the second screw thread may be performed. The first screw thread 110 may be formed by cutting the insulating material i provided on the first can 100. In the step S300 of forming the first screw thread, the first screw thread 110 may be formed on the outer circumferential surface of the first base part 130 from a first end that is adjacent to the bottom part 120 to a second end that is adjacent to the opening in the first can 100.

Similarly, the second screw thread 310 may be formed by cutting the insulating material i provided on the second can 300 to correspond to the first screw thread 110. In the step S300 of forming the second screw thread 310, the second screw thread 310 may be formed on the inner circumferential surface of the second base part 330 from a first end that is adjacent to the cap part 320 to a second end that is adjacent to the opening in the second can 300.

In the step S400 of inserting the electrode assembly into the first can, the electrode assembly 200 may be inserted into the opening at the upper side of the first can 100. The electrode assembly 200 may be accommodated in the first can 100 by a volume formed by the length from the bottom part 120 to the opening at the end of the first base part 130, thereby providing for the capacity of the secondary battery.

In the step S500 of rotating the first can to screw the first can to the second can, the first screw thread 110 and the second screw thread 310 engage with each other. As shown in FIG. 9, the first can 100 accommodating the electrode assembly 200 may be positioned adjacent to the opening at the lower end of the second can 300, and ends of the first screw thread 110 and the second screw thread 310 may be engaged with each other. When the first can 100 is rotated in a certain direction while the first screw thread 110 and the second screw thread 310 are engaged with each other, the first can 100 may be screwed to the second can 300.

The method of manufacturing a secondary battery according to an embodiment of the present disclosure may further include joining a sealing part to the first can after the step S500 of screwing the first can to the second can. In the step S500 of screwing the first can to the second can, a first end of the first can 100 may be completely joined to the end adjacent to the cap part 320 of the second can 300 so that the secondary battery may be sealed. The sealing part 400 may be joined to the lower portion of the first can 100 and may seal an end where the first screw thread 110 and the second screw thread 310 are engaged with each other. This may further enhance the sealing of the assembled secondary battery.

As described above, according to the present disclosure, the cylindrical secondary battery may have insulation between the negative electrode and the positive electrode be sealed by joining the first screw thread 110 and the second screw thread 310. Accordingly, because it is unnecessary to form a beading part or the like for seating a separate insulating gasket, the thickness of the first can 100 or the second can 300 may be reduced and the volume of the electrode assembly may be increased, thereby increasing the capacity of the secondary battery.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

### DESCRIPTION OF SOME REFERENCE SYMBOLS

10: secondary battery
100: first can
101: opening
110: first screw thread
120: bottom part
130: first base part
200: electrode assembly
300: second can
310: second screw thread
320: cap part
330: second base part
400: sealing part

What is claimed is:

1. A secondary battery comprising:
a first can having a first screw thread formed on an outer circumferential surface thereof;
an electrode assembly accommodated in the first can; and
a second can having a second screw thread formed on an inner circumferential surface of the second can, with the second screw thread corresponding to the first screw thread,
wherein the first can and the second can are screwed together by the first and second screw threads to thereby seal an opening of the first can.

2. The secondary battery as claimed in claim 1, wherein the first can comprises:
a bottom part electrically connected to the electrode assembly; and
a cylindrical-shaped base part extending from the bottom part, with the first screw thread being formed on an outer circumferential surface of the base part.

3. The secondary battery as claimed in claim 2, wherein the first screw thread is formed on the outer circumferential surface of the base part from first end that is adjacent to the bottom part to a second end that is adjacent to the opening of the first can.

4. The secondary battery as claimed in claim 2, wherein the bottom part and the base part are formed from nickel or a nickel alloy material.

5. The secondary battery as claimed in claim 1, wherein the second can comprises:
a cap part electrically connected to the electrode assembly; and
a cylindrical-shaped base part extending from the cap part, with the second screw thread being formed on an inner circumferential surface of the base part.

6. The secondary battery as claimed in claim 5, wherein the cap part comprises a current interrupt device.

7. The secondary battery as claimed in claim 5, wherein the second screw thread is formed on the inner circumferential surface of the second base part from a first end that is adjacent to the cap part to a second end that is adjacent to an opening of the second can.

8. The secondary battery as claimed in claim 5, wherein the cap part and the second base part are formed from aluminum or an aluminum alloy material.

9. The secondary battery as claimed in claim 1, wherein the first screw thread and the second screw thread are formed from an insulating material that insulates between the first can and the second can.

10. The secondary battery as claimed in claim 1, wherein the first screw thread and the second screw thread are formed from a polyethylene-based or a polypropylene-based material.

11. The secondary battery as claimed in claim 1, further comprising a sealing part joined to the first can by the first can being screwed to the second can.

12. A method for manufacturing a secondary battery, the method comprising:
coating an insulating material on an outer circumferential surface of a first can;
coating an insulating material on an inner circumferential surface of a second can;
forming a first screw thread by cutting the insulating material of the first can and forming a second screw thread by cutting the insulating material of the second can, with the second thread being formed to correspond to the first screw thread;
inserting an electrode assembly into the first can; and
rotating the first can to screw the first can to the second can while the first screw thread and the second screw thread are engaged to each other.

13. The method as claimed in claim 12, wherein the first can comprises:
a bottom part electrically connected to the electrode assembly; and
a cylindrical-shape base part extending from the bottom part, with the first screw thread being formed in an outer circumferential surface of the base part.

14. The method as claimed in claim 13, wherein, in forming the first screw thread, the first screw thread is formed on the outer circumferential surface of the base part from a first end that is adjacent to the bottom part to a second end that is adjacent to an opening of the first can.

15. The method as claimed in claim 12, wherein the second can comprises:
a cap part electrically connected to the electrode assembly; and
a cylindrical-shaped base part extending from the cap part, with the second screw thread being formed on an inner circumferential surface of the base part.

16. The method as claimed in claim 15, wherein the cap part comprises a current interrupt device.

17. The method as claimed in claim 15, wherein, in forming the second screw thread, the second screw thread is formed on the inner circumferential surface of the base part from a first end that is adjacent to the cap part to a second end that is adjacent to an opening of the second can.

18. The method as claimed in claim 12, wherein the first screw thread and the second screw thread are formed from an insulating material that insulates between the first can and the second can.

19. The method as claimed in claim 12, wherein the first screw thread and the second screw thread are formed of a polyethylene-based or polypropylene-based material.

20. The method as claimed in claim 12, wherein, after the first can to the second can are screwed together, a sealing part is joined to the first can.
